(19) United States
(12) Patent Application Publication
(10) Pub. No.: US 2014/0347660 A1
(43) Pub. Date: Nov. 27, 2014

(54) METROLOGICAL APPARATUS

(71) Applicant: Taylor Hobson Limited, Leicester, Leicestershire (GB)

(72) Inventor: Mathieu Rayer, Leicester (GB)

(73) Assignee: Taylor Hobson Limited, Leicester, Leicestershire (GB)

(21) Appl. No.: 14/366,812

(22) PCT Filed: Dec. 19, 2012
(86) PCT No.: PCT/GB2012/053187

§ 371 Date: Jun. 19, 2014

(30) Foreign Application Priority Data
Dec. 21, 2011 (GB) 1122052.2

(51) Int. Cl. G01J 3/02

(52) U.S. Cl. CPC G01J 3/0262
USPC 356/300

(57) ABSTRACT

Metrological apparatus and a confocal sensor for use in such apparatus are described. The confocal sensor (1) has an optical pinhole (11) adapted for letting through a light beam (2). An optical assembly of the sensor has a first lens (12) having a refractive profile (121) and a diffractive profile (122) and a second lens (13) having at least a refractive profile (131). The refractive profile (121) of the first lens (12) and the refractive profile (131) of the second lens (13) focus the light beam (2) into a focused beam (21). The diffractive profile (122) of the first lens (12) creates longitudinal chromatic aberration so that the focused beam (21) has a focal zone with a longitudinal depth (R).

This invention relates to metrological apparatus using a confocal sensor to determine a surface characteristic and to a confocal sensor for use in such apparatus.

A confocal sensor has confocal apertures (pinholes) designed to inhibit light other than light reflected from a point of focus on a surface under test from entering a detector which generally comprises an array of sensing elements or sensing pixels. This elimination or reduction of out-of-focus and stray light enables higher resolution and higher signal-to-noise ratio to be achieved.

Whether or not a measurement point (surface region or surface pixel) of the surface under test is at the point of focus or not will depend upon the relative surface height of the measurement point on the surface under test. Relative movement between the sample and the detection arrangement (the detector itself or an objective lens) along the optical path (the z direction) causes different relative height measurement points on the surface under test to pass through the focal plane of the confocal sensor. The output signals of the sensing elements of the detector at different positions along the scan path may be used to build up a surface profile of the surface under test. A 2-D image of this surface under test may be built up by relative scanning in x and y directions so that the focused light is incident on different surface pixels of the surface under test.

In order to avoid the need for scanning in the z direction, chromatic confocal sensors have been proposed. Chromatic confocal sensors used an object assembly or objective with a longitudinal chromatic aberration that creates different focus positions for different wavelengths so creating a focal zone with a longitudinal depth. Such confocal sensors may use a broadband or polychromatic (for example white light) light source and a spectrometer, or may use a wavelength tunable source.

The range of relative surface heights that can be detected by a chromatic confocal sensor is limited by the degree of longitudinal chromatic aberration provided by the objective for a defined spectral bandwidth.

The use of a diffractive optical element (DOE), usually a Zone Plate Lens (ZPL), has been proposed to increase the chromatic aberration of the sensor, thereby increasing the longitudinal depth of the focal zone and so increasing the measurement range of the sensor. However, adding an extra optical element, namely the DOE, increases the optical complexity of the sensor. In addition, typically the manufacture of a DOE involves etching a multilevel (usually eight levels) diffractive profile in a glass plate. This manufacturing method is expensive, because it requires expensive lithography equipment, and is slow, because it may take about two hours to manufacture an eight level DOE.

### SUMMARY OF THE INVENTION

Aspects of the present invention address or at least ameliorate the above issue.

According to one aspect, the invention provides a confocal sensor having an optical assembly for directing light from a light source towards a surface having a characteristic to be measured and for supplying light reflected from the surface to a detector, the optical assembly comprising: first and second lenses positioned in series along an optical path of the sensor, the first and second lenses each having a refractive profile to focus light from the light source into a focussed beam, at least one of the first and second lenses also having a diffractive profile to introduce chromatic aberration to cause different wavelengths to focus at different focal points along the optical path thereby resulting in a focal zone having a longitudinal depth along the optical axis, the confocal sensor having an optical aperture to inhibit light other than light reflected from a focus point passing to the detector.

Embodiments comprise at least one lens comprising a diffractive profile for creating a longitudinal chromatic aberration such that the longitudinal depth of the focus zone is relatively large, thereby increasing the measurement range. This diffractive profile is provided on a lens which also has refractive power, so that the sensor does not need to have extra optical element. The sensor can therefore be optically simple. A second lens may further comprise a diffractive profile to provide, in cooperation with the diffractive profile of a first lens, an enhanced longitudinal chromatic aberration.

The diffractive profile can be made by moulding and/or by machining, which enables low cost manufacturing as it does not require an expensive lithography equipment. Also the manufacturing process may be speeded up, especially where the manufacturing process is a moulding process.

The separation of first and second lens may be adjustable to allow modification of the longitudinal depth of the focal zone, enabling dynamic adjustment of the measurement range. The first lens and the second lens may be designed to maintain a nearly constant numerical aperture regardless of any change in their separation. The sensor can also have a relatively low space requirement.

The first lens and the second lens may be configured to cause overlap of a plurality of diffractive modes of the focused light beam to provide enhanced measurement resolution.

According to another aspect, the invention provides apparatus comprising at least one sensor according to aspects of the invention and a detector for detecting light passing through the optical aperture and for providing a wavelength-dependent signal.

The detector may comprise a wavelength separator and a sensor. The apparatus may further comprise a polychromatic light source, and may comprise a fibre optic coupling for transmitting light from the light source to the sensor and a fibre optic coupling for transmitting light from the sensor to the detector. The detector may comprise a band pass filter or a light intensity detector.

According to another aspect, the invention provides at least one of a system, an endoscopic system and a tool setter, comprising an apparatus according to aspects of the invention.

### BRIEF DESCRIPTION OF THE DRAWINGS

Embodiments of the invention will now be described, by way of example, with reference to the accompanying drawings, in which:

FIG. 1 is a schematic diagram of metrological apparatus according to the invention comprising a confocal sensor and a detector;

FIG. 2 is a schematic diagram of one example of the sensor;

FIG. 3 shows the diffraction efficiency curves of the diffraction modes m=8, 7, 6, 5, 4 of an objective of a thickness order p=6, for a design wavelength of 525 nm when illuminated by white light,

FIG. 4 shows the spatial overlap of three rays corresponding to three different diffraction modes, and

FIGS. 5A and 5B schematically show the use of a sensor in accordance with the invention for tool setting.

### DETAILED DESCRIPTION OF THE INVENTION

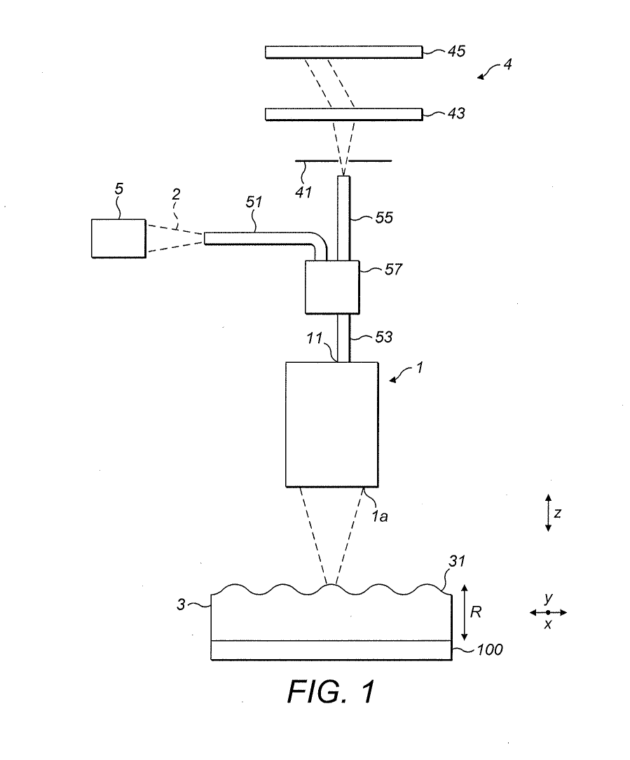

Referring now to the drawings, FIG. 1 shows a schematic diagram of metrological apparatus. The apparatus comprises a polychromatic light source 5 to direct light 2 along a first optical path 51 to an optical coupler 57. The optical coupler 57 is arranged to direct light received from the polychromatic light source 5 along a second optical path 53 to an optical pinhole or aperture 11 of a confocal sensor 1. The confocal sensor is arranged to cause light received from the light source 5 to be incident on a surface 31 of a sample object 3, such as a workpiece, mounted on a sample stage 100 and to cause light reflected from the surface to be directed back along the optical path 53 via the optical pinhole or aperture 11 to the optical coupler 57 which is arranged to direct the reflected light to a detector 4 along a third optical path 55.

In this example, the optical paths 51, 53 and 55 are provided by fibre optic cable, although in some circumstances the optical path may be through air. In the example shown, the optical coupler 57 is a Y coupler. As another possibility, the optical coupler may be a beam splitting prism.

The optical pinhole 11 may be an actual hole in a panel or a diaphragm, but in this example is provided by the end face of the fibre optic cable 53 coupled to the sensor 1.

In this example the detector 4 has a sensing device 45. The sensing device 45 may comprise a 1D or 2D array of sensing elements and may for instance be a Charge-Coupled Device (CCD) or a Complementary Metal-Oxide Semiconductor (CMOS) sensor. The detector also has a wavelength separator 43 to separate different wavelengths to cause different wavelengths to be incident on different sensing elements of the sensing device 45. The wavelength separator 43 may be a spectrometer grating but could also be a linear variable filter or a band pass filter or also may be an imager. The detector 4 may have an optional optical pinhole 41 to enhance filtering of the light.

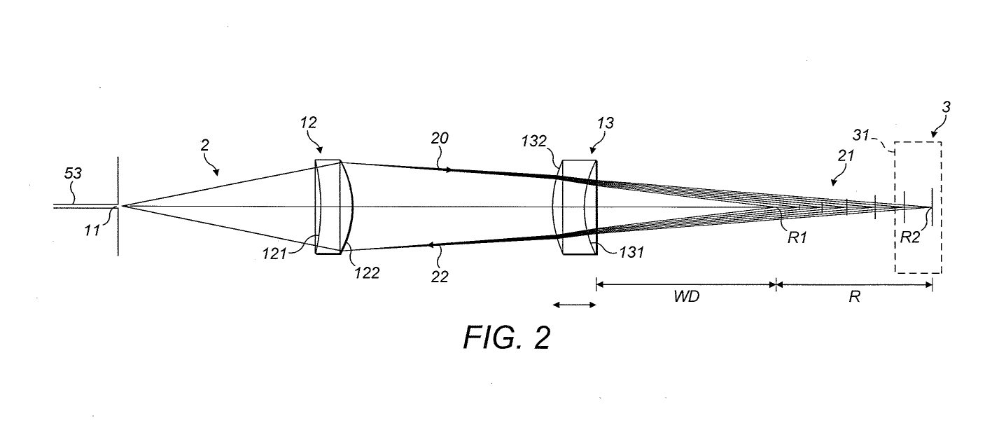

An embodiment of the confocal sensor 1 is shown in FIG. 2.

In this example, the confocal sensor 1 has first and second lenses 12 and 13 spaced apart along an optical path from the optical pinhole 11 to an exit aperture 1a (FIG. 1) of the confocal sensor 1.

The first lens 12 has a refractive profile 121 and a diffractive profile 122 whilst the second lens 13 has at least a refractive profile 131.

The refractive profiles 121 and 131 of the first and second lenses 12 and 13 act to provide a focussed light beam directed toward the surface 31 of the object 3. In the example shown in FIG. 2, the refractive profiles 121 and 131 are provided by a surface of the first lens 12 facing towards the optical aperture 11 and a surface of the second lens 13 facing away from the first lens 12.

The diffractive profile 122 of the first lens 12 introduces longitudinal chromatic aberration so that different wavelengths are focussed at different focal points causing the focused beam 21 to have a focus zone with a longitudinal depth R, where R is the distance between the proximal and distal focus points R1 and R2. The depth R determines the measurement range of the confocal sensor, that is for example the surface height difference that can be measured by the confocal sensor.

In operation of the apparatus, an object having a surface profile to be measured is positioned on the sample stage 100. Light 20 on a forward path from the polychromatic light source 5 is focussed by the confocal sensor onto a surface of the sample 3 and light 22 reflected by the surface is transmitted along a return path through the lens 13 and the lens 12.

Light that is focussed onto the sample surface is reflected back and focussed on the pinhole 11 but most if not all of any other light reflected from the surface is blocked or filtered out by the pinhole 11. Whether or not a particular wavelength is focussed on the surface of the sample 3 will depend upon the relative height of the surface that is the location within the range R at which the surface lies.

Light passing through the pinhole 11 travels via the Y coupler 57 to the optical path 55, through the pinhole 41 (if present), to the detector 4 and is imaged by the wavelength separator 43 onto the sensing device 45. Different wavelengths are incident on different sensing elements and the outputs of the sensing elements may then be processed by computing apparatus (not shown) to determine the sensing element (and so the wavelength) providing the highest output signal. Relative movement between the sample stage 100 and the detector (or objective lens) in the x and/or y directions enables the measurement to be repeated for other positions of the surface and the resultant power spectra analysed to build up a surface profile (in x or y) or a surface map (in x and y) which relates the focussed wavelength identified from the power spectra to relative surface height. If the object is at least partially transmissive, then the power spectra may include other peaks resulting from reflection from refractive index boundaries below the front surface of the sample, for example from within the object or from its back surface. These power spectra may be analysed to determine structure within the object.

The apparatus may be calibrated using a calibration object having a surface with a precisely defined known form.

The second lens 13 may also have a diffractive profile 132 which cooperates with the diffractive profile 122 of the first lens 12 to provide a further enhanced longitudinal chromatic aberration, resulting in a greater depth R and thus a greater measurement range. In the example shown in FIG. 2, the diffractive profiles are provided on facing surfaces of the first and second lenses 12 and 13.

According to an advantageous embodiment, the refractive profile 121 of the first lens 12 and the refractive profile 131 of the second lens 13 are spherical profiles. Spherical profiles are easier and cheaper to manufacture. It should be noted however that the profiles 121 and 131 could also be aspherical profiles. The refractive profiles of the first and second lenses may be different.

The diffractive profile 122 of the first lens 12 and/or the diffractive profile 132 of the second lens 13 may be spherical or aspherical profiles. Aspherical profiles are advantageous in terms of providing a better efficiency for the design of the diffractive profiles 122 and/or 132.

Advantageously, the first lens 12 and/or the second lens 13 are moulded and/or machined.

Machining of the lenses 12 and/or 13 can be done accurately using for instance a diamond turning machine tool. Preferably, the machining of the diffractive profiles 122 and/or 132 is carried out on an existing aspherical (or spherical) profile of the lens 12 and/or 13, respectively.

Moulding of the lenses 12 and/or 13 advantageously results in a significant reduction of the manufacturing time.

The lenses 12 and/or 13 may be made out of a plastics material or glass, with a significant reduction of the weight of the lenses 12 and/or 13 in the case of a plastics material.

One or both of the lenses 12 and 13 may be movable longitudinally (that is along the optical path or axis). For example, the second lens 13 may be movable towards or away from the first lens 12 to modify the longitudinal depth R of the focus zone, enabling dynamic adjustment of the measurement range R.

It is advantageous that the second lens 13, rather than the first lens, is longitudinally movable, because the first lens 12 receives the light beam 20 from the pinhole 11 and thus first creates the chromatic aberration on the forward path towards the sample or object under test. Therefore by longitudinally moving only the second lens 13, the first lens 12 is always at an appropriate distance from the pinhole 11 and the depth R of the focused beam 21 can still be modified by a factor of typically five. It should be however understood that the first lens 12 could also be longitudinally movable, in lieu of the second lens 13 or as well as the second lens 13.

In embodiments of the invention, the refractive optical power of the refractive profiles 121 and 131 enables focusing the light beam 2 on the object 3, with a nearly constant numerical aperture and a small magnification for the sensor 1, even in the case where the second lens 13 is longitudinally movable with respect to the first lens 12.

In embodiments of the invention, the diffractive chromatic aberration of the diffractive profile 122 (and optionally of the profile 132) is greatly sensitive to the wavelength and therefore provides chromatic aberration with an enhanced efficiency compared to refractive profiles.

A ratio r of the sensor 1 may be defined as:

$$r = \frac{WD}{R}$$

where WD is the distance between the second lens 13 and the proximal focusing point R1 of the focal zone, and where R is the longitudinal depth of the focused beam 21, as shown in FIGS. 1 and 2.

Advantageously, the first lens 12 and the second lens 13 are configured such that the sensor 1 has a low value of the ratio r. When the sensor 1 have a low value of the ratio r, the dispersion curve of the focal distance (and therefore depth R) of the sensor 1 shows a nearly linear behaviour as a function of the wavelength λ. Typical values of r may be comprised between 1.5 and 3. However the first lens 12 and the second lens 13 may be configured such that the sensor 1 has lower values of the ratio r.

Typically R lies in the range from 100 μm to 30 mm (for instance is 400 μm or 25 mm). WD may lie in the range from 10 mm to 80 mm (for instance 12.6 mm or 71 mm).

For a sensor with R=25 mm and WD=71 mm, r is therefore equal to 2.84, which means that the depth R is nearly linearly modified as a function of the wavelength λ.

A sensor with R=10 mm and WD=12.6 mm is compact and has a low space requirement making it suitable for use where space is restricted, for example where measurement is required of surfaces that are difficult to access, for example recessed surfaces and/or surfaces of objects having a complex shape. Such a sensor 1 may also be useful in endoscopy applications.

If R=400 μm, then the numerical aperture of the sensor can be as high as 0.48. High values of the numerical aperture of the sensor enable measurement of surfaces having a great angle with respect to the focused beam (i.e. steep surfaces).

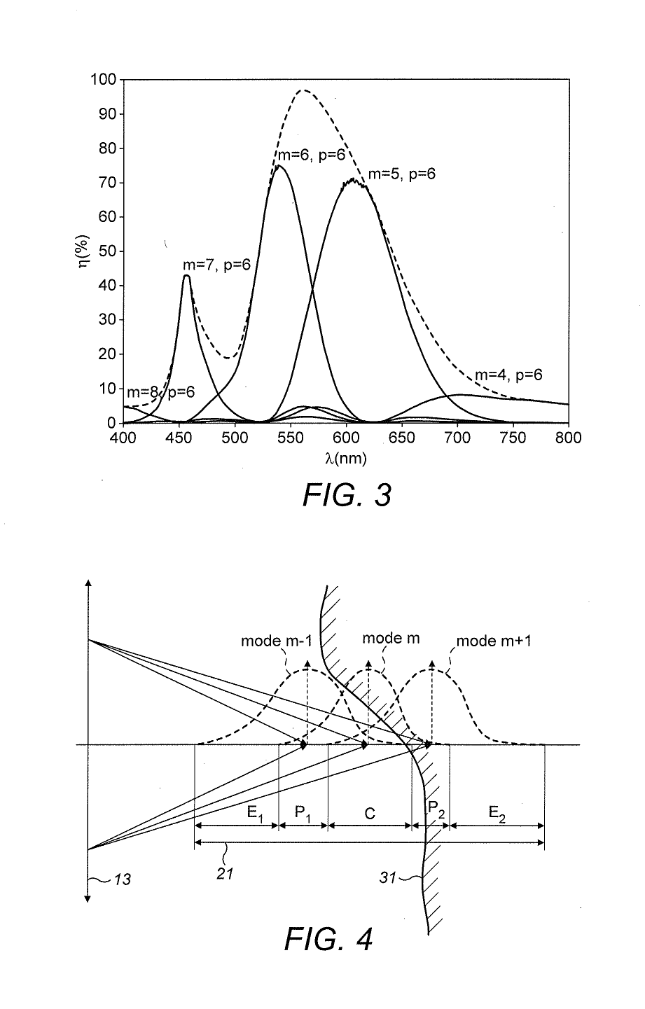

FIG. 3 shows a graph of diffraction efficiency η (%) against wavelength. The solid curves show the diffraction efficiency of the diffraction modes m=8, 7, 6, 5, 4 of a diffractive objective of a thickness order p=6 (for a design wavelength λ₀ of 525 nm (with a focal length F₀)), when illuminated by a white light LED (dashed curve). It can be seen that modes m=7, 6 and 5 overlap spectrally (i.e. with respect to the wavelength λ).

As set out in equation 1 below modes m can also overlap spatially in the focused beam 21, because the focal length F depends upon the wavelenath λ:

$$F ( λ ) = \frac{p {λ}_{0} {F}_{0}}{m λ} \qquad ( Equation 1 )$$

The first lens 12 and the second lens 13 may therefore be designed such that the spectrally overlapping modes (modes m=7, 6 and 5 of FIG. 3 for instance) also overlap spatially.

FIG. 4 shows a graph of diffraction efficiency q against distance along the optical path for a sensor in which the lenses 12 and 13 are designed such that the light rays for a plurality of spectrally overlapping diffraction modes also at least partially overlap spatially in a main overlapping zone, referred to as C, of the focus zone, and such that there is also some spatial overlap in zones on each side of the zone C. For instance, in the example illustrated in FIG. 4, three modes m−1, m and m+1 overlap in the zone C, two modes m−1 and m overlap in zone P1, two modes m and m+1 overlap in zone P2 but only one mode m−1 exists in zone E1 and only one mode m+1 exists in zone E2. Preferably the zone C is located in the middle of the focus zone.

With such a configuration, the focus point corresponding to the surface under examination may, depending on the longitudinal position of the surface in the range R, include light rays from more than one diffraction mode, so that a corresponding number of rays are reflected back and detected by the detector, instead of a single ray. In such an example, the detector 4 may have an extra band pass filter to separate the different diffraction mode rays, and extra sensors to measure each ray respectively.

This should enhance the resolution of the measurement of the profile of the surface 31, because each different diffraction mode ray provides an independent measurement, which improves the signal-to-noise ratio. Typically, the lenses 12 and 13 can be designed to cause spatial overlap of x different diffraction mode rays in the focused beam 21. The signal-to-noise ratio may be improved by up to:

\sqrt{x}

by just averaging the measurements where the surface is in the zone C of the range R for instance. As an example if x is for instance 3, and may correspond to modes 7, 6 and 5 of FIG. 3, then the signal-to-noise ratio may be improved by up to:

\sqrt{3}≈1.732

by averaging three measurements for three modes.

Of course the signal-to-noise ratio may also improved for measurements taken in the zones P1 and P2, but this time by

\sqrt{2}=1.414

in the above example, by averaging two measurements for two modes, because there are only two spectrally overlapping modes in these zones.

The number of overlapping modes may be increased by increasing the thickness order of the lenses 12 and 13, or may be decreased by decreasing the thickness order of the lenses 12 and 13.

Also, if the spectral reflectance of the surface 31 is known, the reflected intensity balance between the reflected rays in the different diffraction modes can be used as an extra and independent measurement, to further improve the signal-to-noise ratio, if the detector 4 has an extra light intensity detector.

In the example shown in FIG. 2, the refractive profile 121 and the diffractive profile 122 of the first lens 12 are located on opposite profiles of the lens 12. It should be noted that the respective positions of the profile 121 and the profile 122 along the optical path do not influence the operation of the sensor, and thus the first lens could be a mirror image about the optical path of that shown, so that the respective locations of the profiles 121 and 122 on the lens 12 of FIG. 3 are reversed. Similarly, the second lens could be a mirror image about the optical path of that shown in FIG. 2, so that the refractive profile 131 is on the other surface of the second lens 13. Also the order of the first lens 12 and the second lens 13 could be reversed so that light directed towards the sample surface passes first through the second lens and then the first lens.

The sensor may be used for precise and quick non-contact measuring of distances and profiles in various domains of metrology, but may also used for instance in endoscopy and for tool setting.

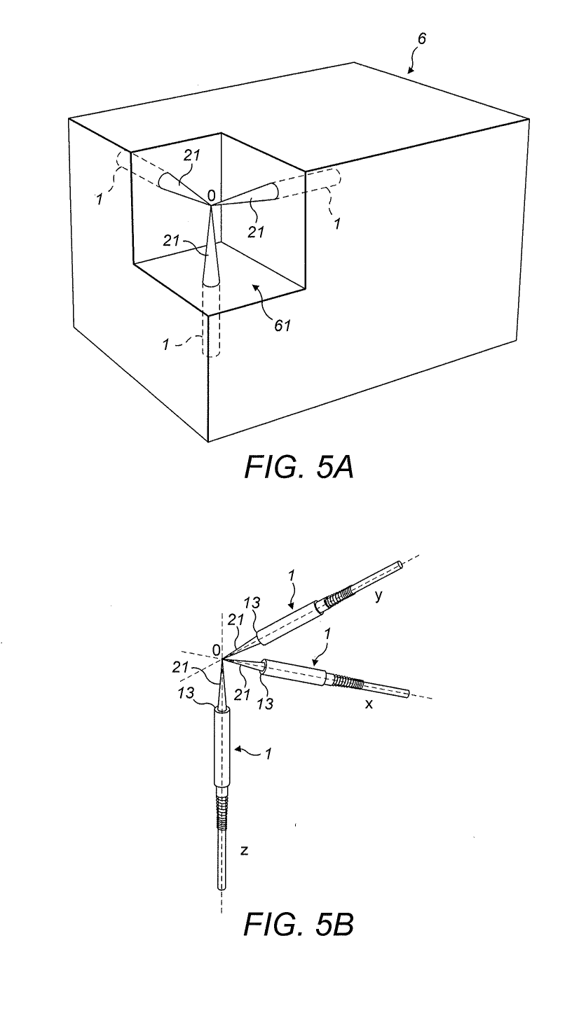

FIGS. 5A and 5B schematically show the use of apparatus 6 incorporating sensors as described above for tool setting.

In this example, the apparatus 6 has three orthogonal sensors 1 to enable measurements in each of three orthogonal directions x, y and z. The sensors are arranged so that their respective focused beams 21 intersect at a measurement centre O. The area defined by the focused beams 21 therefore defines a measuring area 61. The apparatus 6 may be used for instance for
tool checking, for instance for checking for broken teeth, chips, wear, etc. of a tool (such as a side cutter on a milling machine) placed in the area 61;
dimensional checking, for instance for roundness, cutting diameter, etc.
3D mapping;
simple referencing in 3D.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A confocal sensor having an optical assembly for directing light from a light source towards a surface having a characteristic to be measured and for supplying light reflected from the surface to a detector, the optical assembly comprising:
first and second lenses positioned in series along an optical path of the sensor, the first and second lenses each having a refractive profile to focus light from the light source into a focussed beam, at least one of the first and second lenses also having a diffractive profile to introduce chromatic aberration to cause different wavelengths to focus at different focal points along the optical path thereby resulting in a focal zone having a longitudinal depth along the optical axis, the confocal sensor having an optical aperture to inhibit light other than light reflected from a focus point passing to the detector.

2. The confocal sensor of claim 1, wherein at least one of first lens and the second lens is movable along the optical axis to modify the longitudinal focal depth of the focused beam.

3. The confocal sensor of claim 1, wherein at least one of the first and second lenses is manufactured by at least one method chosen from the group consisting of moulding and machining.

4. The confocal sensor of claim 1, wherein at least one of the refractive profile of the first lens and the refractive profile of the second lens comprises a spherical profile.

5. The confocal sensor of claim 1, wherein the diffractive profile of the first lens comprises an aspherical profile.

6. The confocal sensor of claim 1, wherein the diffractive profile of the first lens is located on a surface of the first lens opposed to the refractive profile.

7. The confocal sensor of claim 1, wherein the refractive profile of the second lens is on a surface of the second lens facing away from the first lens.

8. The confocal sensor of claim 1, wherein the second lens further comprises:
a diffractive profile to provide, in cooperation with the diffractive profile of the first lens, an enhanced longitudinal chromatic aberration.

9. The confocal sensor of claim 8, wherein the diffractive profile of the second lens faces the first lens.

10. The confocal sensor of claim 8, wherein the diffractive profile of the second lens comprises an aspherical profile.

11. The confocal sensor of claim 1, wherein the first lens and the second lens are configured to cause overlap of a plurality of diffractive modes in the focal zone.

12. The confocal sensor of claim 1, wherein the first lens and the second lens are configured so that the sensor has a ratio r such that:
1.5≦r≦3.0,
where r is defined as:
$$r = \frac{WD}{R}$$
where WD is a distance between the second lens and a proximal focal point of the focal zone, and
R is the longitudinal depth.

13. Apparatus comprising a confocal sensor comprising:
an optical pinhole adapted for letting through a light beam;
a first lens located downstream the optical pinhole in a forwards path of the light beam, and comprising:
a refractive profile facing the pinhole, and
a diffractive profile located on an opposite surface of the first lens with respect to the refractive profile; and
a second lens located downstream the first lens in the forwards path of the light beam, and comprising:
a refractive profile located on an opposite surface of the second lens with respect to the first lens, the refractive profile of the first lens and the refractive profile of the second lens being adapted for focusing the light beam into a focused beam in the forwards path; and
a diffractive profile facing the first lens and adapted for creating, in cooperation with the diffractive profile of the first lens, an enhanced longitudinal chromatic aberration so that the focused beam has a longitudinal depth;
wherein the second lens is further adapted for longitudinal movement with respect to the other lens, for modifying the longitudinal depth of the focus zone.

14. The apparatus of claim 13 further comprising:
a detector for detecting light passing through the optical aperture and for providing a wavelength-dependent signal.

15. The apparatus of claim 14, wherein the detector comprises a wavelength separator and a sensor.

16. The apparatus of claim 14, further comprising:
a polychromatic light source.

17. The apparatus of claim 14, further comprising:
a fibre optic coupling for transmitting light from the light source to the sensor and a fibre optic coupling for transmitting light from the sensor to the detector.

18. The apparatus of claim 14, wherein the detector further comprises a band pass filter.

19. The apparatus of claim 14, wherein the detector further comprises a light intensity detector.

20-21. (canceled)

22. A system comprising:
a polychromatic light source for creating a light beam;
a confocal sensor;
a fibre optic coupling for transmitting the light beam from the light source to the sensor, the fibre optic coupling providing an optical pinhole;
wherein the confocal sensor has an optical path with:
a first lens to receive light passing through the optical pinhole, and
a second lens to receive light from the first lens,
wherein the first lens comprises:
a refractive profile provided by a first surface of the first lens facing the pinhole, and
a diffractive profile provided by a second surface opposed to the first surface of the first lens;
wherein the second lens comprises:
at least a refractive profile provided by a first surface of the second lens opposed to the second surface of the first lens;
wherein the refractive profile of the first lens and the refractive profile of the second lens are configured to focus the light beam to a focused beam to be directed towards an object under test, and
wherein the diffractive profile of the first lens is configured to create longitudinal chromatic aberration along the optical path so that the focused beam has a focal zone with a longitudinal depth;
a second fibre optic coupling for transmitting light that has been reflected from the object to the optical pinhole; and
a detector for receiving light passing through the optical pinhole, the detector comprising a wavelength separator and at least a sensor.

23-25. (canceled)
